(19) United States
(12) Patent Application Publication
(10) Pub. No.: US 2009/0182899 A1
(43) Pub. Date: Jul. 16, 2009

(54) METHODS AND APPARATUS RELATING TO WIRE FORMATS FOR SQL SERVER ENVIRONMENTS

(75) Inventors: Il-Sung Lee, Seattle, WA (US); Xinwei Hong, Sammamish, WA (US); Peter Gvozdjak, Sammamish, WA (US); Chadwin James Mumford, Woodinville, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/014,534

(22) Filed: Jan. 15, 2008

(51) Int. Cl. G06F 15/173

(52) U.S. Cl. 709/246

(57) ABSTRACT

Systems and methods are provided, wherein the method includes retrieving and/or storing one or more data types representative of a selected date and/or time value from a server to a client in a server/client SQL environment using a selected wire format. Another aspect provides apparatus including a SQL server, a SQL client operationally coupled to the server, and means to transmit the selected time/date data types between the server and the client according to a selected wire format. In an illustrative implementation, the wire format translates the date/time data into a binary format.

### BACKGROUND

Networked computing environments allow for the communication of data across enterprises having geographic disparate locations. A commonly deployed networked computing environment is a client/server computing environment where one or more client computing environments cooperate with one or more server computing environments to communicate data and executables. These communications can encounter latency depending on the quality of the communications link (e.g., communications network) between an exemplary client and server. Factors that can influence the speed at which data is communicated can include but are not limited to geographic locations of the client/server, respectively, the bandwidth available over the communications network, and the format of the data being communicated.

Current practices employ one or more techniques/mechanisms which aim to reduce communication latency and provide better accuracy between a requesting/responding client server/pair. Accuracy can be an important consideration as is appreciated when attaching a date and/or time to data being communicated. Current practices to decrease latencies include but are not limited to increased bandwidth (e.g., fiber optic) communications networks, data types having limited sizes, and data formats (e.g., wire format) that represent data according to a selected data communications protocol operable to reduce latency and increase accuracy.

However, current practices fall short to address the latencies realized from communications between a client and server in a SQL environment used to communicate highly granular data and/or time data.

From the foregoing it is appreciated that there exists a need to overcome the shortcomings of existing practices as it pertains to wire formats for server/client SQL environments.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

In one aspect, a method is provided, wherein the method includes retrieving and/or storing one or more data types representative of a selected date and/or time value from a server to a client in a server/client SQL environment (i.e., SQL SERVER® environment) using a selected wire format. Another method includes retrieving and/or storing one or more data types representative of a selected data and/or time value from a client to a server in a server/client SQL environment using a selected wire format. Another aspect provides an apparatus including a SQL server, a SQL client operationally coupled to the server, and means to transmit the selected time/date data types between the server and the client according to a selected wire format. Yet another aspect provides a method including embedding tabular information representative of a selected data/time data type into a binary wire format in a client/server SQL environment, and transferring the binary wire format from at least one of a client and a server to at least one of the client and the server to create a selected data/time data type wire format.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of an illustrative implementation of an exemplary client/server SQL environment.

FIG. 2 is a block diagram of an illustrative implementation of a data type engine for use in generating and processing wire formats.

FIG. 3 is a block diagram of an exemplary description of illustrative data types for use to generate wire formats.

FIG. 4 is a block diagram showing exemplary processing performed to generate date/time data type wire formatting.

FIG. 5 is a block diagram showing exemplary processing when processing wire format data across an exemplary client/server SQL environment.

FIG. 6 is a block diagram of an exemplary networked computing environment in accordance with various aspects described herein.

FIG. 7 is a block diagram of an exemplary computing environment in accordance with various aspects described herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It is further appreciated that the herein usage of the term server/client SQL environment is intended to cover various implementations of SQL computing environments deploying one or more features of MICROSOFT® SQL SERVER®.

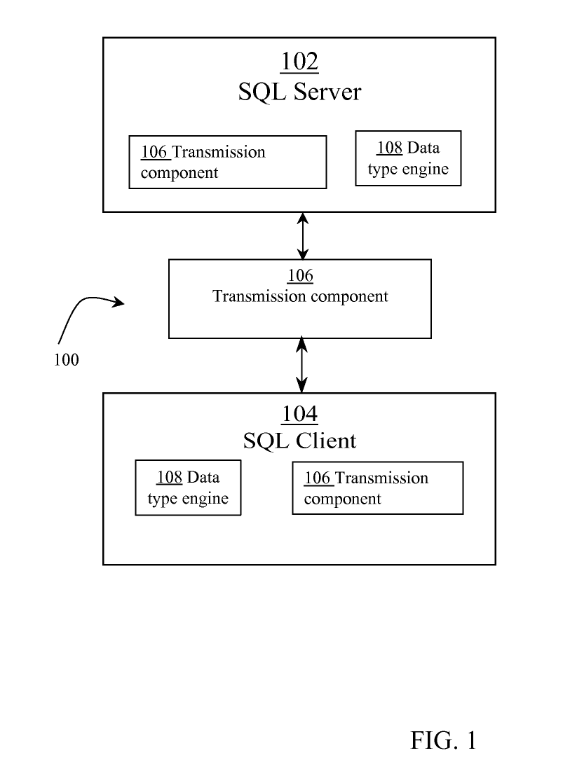

FIG. 1 illustrates a system 100 including a SQL server 102, a SQL client 104 that is operationally coupled to the SQL server 102, and a transmission component 106 that wire format data as provided by data type engine 108 between the SQL server 102 and the SQL client 104. As illustrated the component 106 can be separate from the SQL server 102 and the SQL client 104 or integrated within either or both of the SQL server 102 and the SQL client 104. Additionally, as is shown data type engine 108 can reside on SQL server 102 and on SQL client 104.

### Overview: Wire Formats

In an illustrative implementation exemplary SQL environment 100 can deploy an application-level protocol that uses one or more selected wire formats (e.g., one or more selected binary (or other low overhead) data formats for one or more selected data types) when communicating data between exemplary SQL client 104 and exemplary SQL server 102. The SQL communication data packets can be encapsulated in the packets built for the protocol stack used by one or more communication protocol libraries (not shown) executing in exemplary SQL environment 100. By way of example, if TCP/IP sockets communication protocol library is employed by exemplary SQL environment 100, then SQL communication data packets (having wire format packets expressing various data types) can be encapsulated in the TCP/IP packets of the underlying protocol.

In an illustrative implementation, the contents of the packets that send result sets back to a requesting application (not shown) (e.g., operating on SQL client 104) depends on whether one or more selected options are executed. By way of example, if the “FOR XML” operation is specified in the SQL query communicated from SQL client 104 to SQL server 102. For example, if the “FOR XML” option is not specified, SQL server 102 can communicate a relational result set back to requesting SQL client 104. In the illustrative operation, the SQL data communication packets can contain the rows of the result set, with each row comprised of one or more columns, as specified in the select list of the exemplary query. Conversely, if the “FOR XML” option is specified, SQL server 102 can operate to stream an XML document back to requesting SQL client 104. Illustratively, operatively, the requested XML document can be formatting in the communication protocol packets (as expressed by various wire formats) as if it were a single, long Unicode value.

### Wire Formats: Date and Time Data Types

In an illustrative implementation, one or more date and/or time data types can be deployed in exemplary SQL environment 100. In the illustrative implementation, one or more selected wire formats are provided to express the exemplary date and/or time data types according to a selected SQL communication protocol (i.e., as described above). By way of example, the following illustrative date/time data types having exemplary described characteristics (e.g., TIME data type having a nine position ‘seconds’ value granularity—two integers for the whole seconds and up to seven positions representing fractional seconds) can be deployed in exemplary SQL environment 100:

| | | | Time Zone Aware | User defined |
|---|---|---|---|---|
| New Type | Precision | Date Range | and preservation | fractional precision |
| DATE | 1 day | 1-1-1 through 9999-12-31 | no | No |
| TIME | 100 ns | 00:00:00.0000000 through | no | Yes |
| | | 23:59:59.9999999 | | |
| DATETIME | 100 ns | 1-1-1 00:00:00.0000000-12:59 through | Yes | Yes |
| OFFSET | | 9999-12-31 23:59:59.9999999 14:00 | | |
| DATETIME2 | 100 ns | 1-1-1 00:00:00.0000000 through 9999-12-31 | No | Yes |
| | | 23:59:59.9999999 | | |

In the illustrative implementation, the new data types can be represented as separate data types in an exemplary SQL communications protocol. Illustratively, the data types can be variable types (to support NULL-ability) having a 1 byte length operable to hold the maximum size of each of the data types. Further, in the illustrative implementation, a wire format can be created for each of the date and/or time data types which, illustratively operatively communicate one or more requests to store/retrieve one or more of the exemplary time and/or date data types from an exemplary SQL client to an exemplary SQL server.

In the illustrative implementation, the exemplary date data type DATETIMEOFFSET (e.g., which illustratively can represent a new time zone) can be associated a wire format as expressed by the following:

```
    CREATE TABLE Table1 (col1 DATETIMEOFFSET(2));
    INSERT INTO Table1 (col1) VALUES ( ‘2006-1-1 12:34:56:78 -
08:00’);
    Client: SQL statement “SELECT * FROM Table1”
```

| Server:COLMETADATA 0x81 | | // |
|---|---|---|
| COLMETADATA_TOKEN | | |
| | 0x0100 | // Row |
| count | | |
| | 0x00000000 0900 | // |
| UserType, Flags | | |
| TYPEINFO 0x2B 02 | | // type, |
| scale | | |
| | 0x04 6300 6F00 6C00 3100 // “col1” | |
| ROW | 0xD1 | |
| | 0x08 | // Byte |
| length | | |
| | 0x0E 1E 45 04 2E 0B FE 20 // ‘2006-1- | |
| 1 12:34:56:78 -08:00’ | | |
| DONE | 0xFD | |
| | 0x1000 | // Status |
| (DONE_COUNT) | | |
| | 0xC100 | // |
| Command (SELECT) | | |
| | 0x0100000000000000 | // Row |
| count | | |

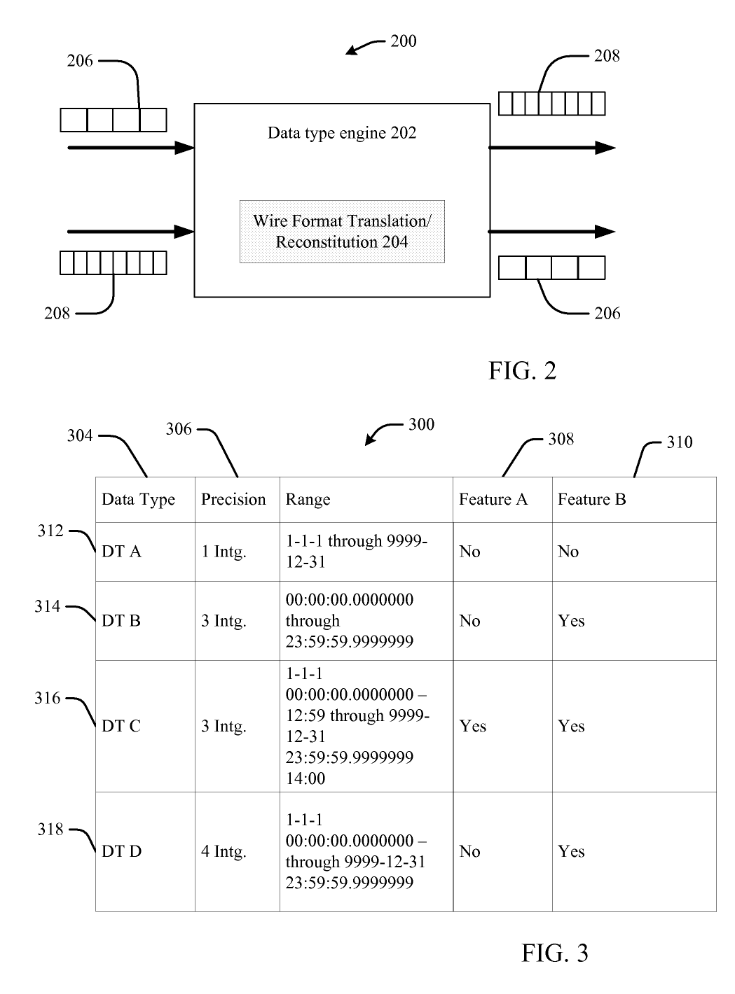

FIG. 2 illustrates a block diagram of an illustrative implementation and operation of an exemplary data type engine for use in generating wire formats representative of one or more date and/or time data types. As is shown, data type engine mechanism 200 can comprise data type engine 202 and wire format translation/reconstitution instruction set 204. In an illustrative operation, string data (e.g., full query string) 206 can be received by data type engine 202 and processed according wire format translation/reconstitution instructions 204 to generate wire format data 208. Conversely, in the illustrative operation, data type engine 202 can receive as input wire format data 208 for reconstitution into string data 206 according to processing prescribed by wire format translation/reconstitution instructions 204. It is appreciated that data type engine mechanism 200 can reside on either of the SQL client and/or SQL server of an exemplary SQL environment.

It is further appreciated that that the wire format described herein is exemplary and the herein described systems and methods are not limited to this illustrative wire format as other SQL communication protocol data expressions are contemplated by the herein described systems and methods.

FIG. 3 illustrates an exemplary description of illustrative data types deployable in an exemplary SQL environment requiring wire format translation/constitution as per the processing. In an illustrative operation, the generated wire format generated for the exemplary data types can be based on data gleaned from such an exemplary description such that desired characteristics of illustrative data types (e.g., range of data type values) are expressed by the generated wire format.

As is shown, data type description 300 comprises one or more descriptors. Illustratively data description 300 comprises descriptor 304 (Data Type), 306 (Precision of the Data Type), 308 (Range of Values For The Data Type), 308 (Feature A—e.g., time zone sensitivity for a temporal based data type), and 310 (Feature B—e.g., required fractional precision for a temporal based data type). Further, as is shown in FIG. 3, data type description 300 comprises values for each data type 312, 314, 316, and 318, respectively for each of the provided descriptors 304, 306, 308, 310.

It is appreciated that although exemplary data type description 300 is presented to include exemplary data about one or more data types for use in generating desired wire formats that such description is merely illustrative as the herein described systems and methods contemplate the use of various data type descriptions.

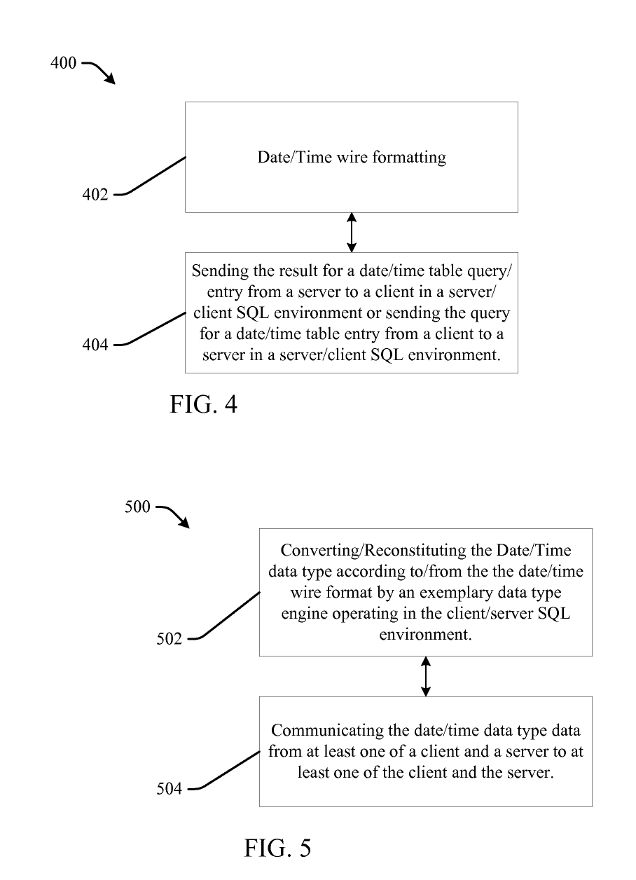

FIG. 4 illustrates a method 400 for communicating date/time data types according to a selected wire format. As is shown, in an illustrative operation, date/time wire formatting block 402 can be employed when a result for a date/time table query/entry from an exemplary SQL server to a client in an exemplary SQL environment as described by block 404. In the illustrative operation, date/time wire formatting process 402 can generate one or more wire formats for date/time data types communicated between the exemplary SQL server and exemplary SQL client.

In another illustrative operation, date/time wire formatting step 402 can be employed when sending a query from a date/time table entry from an exemplary SQL client to an exemplary SQL server in an exemplary SQL client/server environment as described by block 404. In the illustrative operation, date/time wire formatting process 402 can generate one or more wire formats for date/time data types communicated between the exemplary SQL client and exemplary SQL server.

FIG. 5 illustrates a method 500 for processing wire formats representative of data/time data types operatively communicated in an exemplary SQL environment. As is shown block 502 describes the process for converting/reconstituting date/time data type according to a selected one or more wire formats by an exemplary data type engine operating in an exemplary client/server SQL environment. Operatively, this process is used when communicating date/time data type data from at least one of a client and a server to at least one of the client and server as described in block 504 of exemplary wire format processing method 500.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

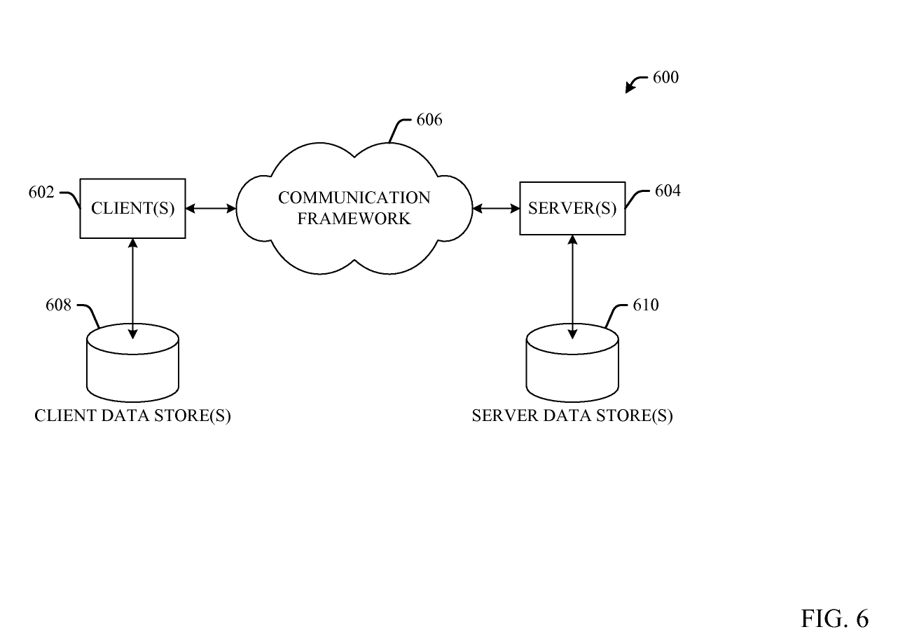

Referring now to FIG. 6, there is illustrated a schematic block diagram of a computing environment 100 in accordance with the subject specification. The system 600 includes one or more client(s) 602. The client(s) 602 can be hardware and/or software (e.g., threads, processes, computing devices). The client(s) 602 can house cookie(s) and/or associated contextual information by employing the specification, for example.

The system 600 also includes one or more server(s) 604. The server(s) 604 can also be hardware and/or software (e.g., threads, processes, computing devices). The servers 604 can house threads to perform transformations by employing the specification, for example. One possible communication between a client 602 and a server 604 can be in the form of a data packet adapted to be transmitted between two or more computer processes. The data packet may include a cookie and/or associated contextual information, for example. The system 600 includes a communication framework 606 (e.g., a global communication network such as the Internet) that can be employed to facilitate communications between the client(s) 602 and the server(s) 604.

Communications can be facilitated via a wired (including optical fiber) and/or wireless technology. The client(s) 602 are operatively connected to one or more client data store(s) 608 that can be employed to store information local to the client(s) 602 (e.g., cookie(s) and/or associated contextual information). Similarly, the server(s) 604 are operatively connected to one or more server data store(s) 608 that can be employed to store information local to the servers 604. Additionally, the server and client can be on the same machine.

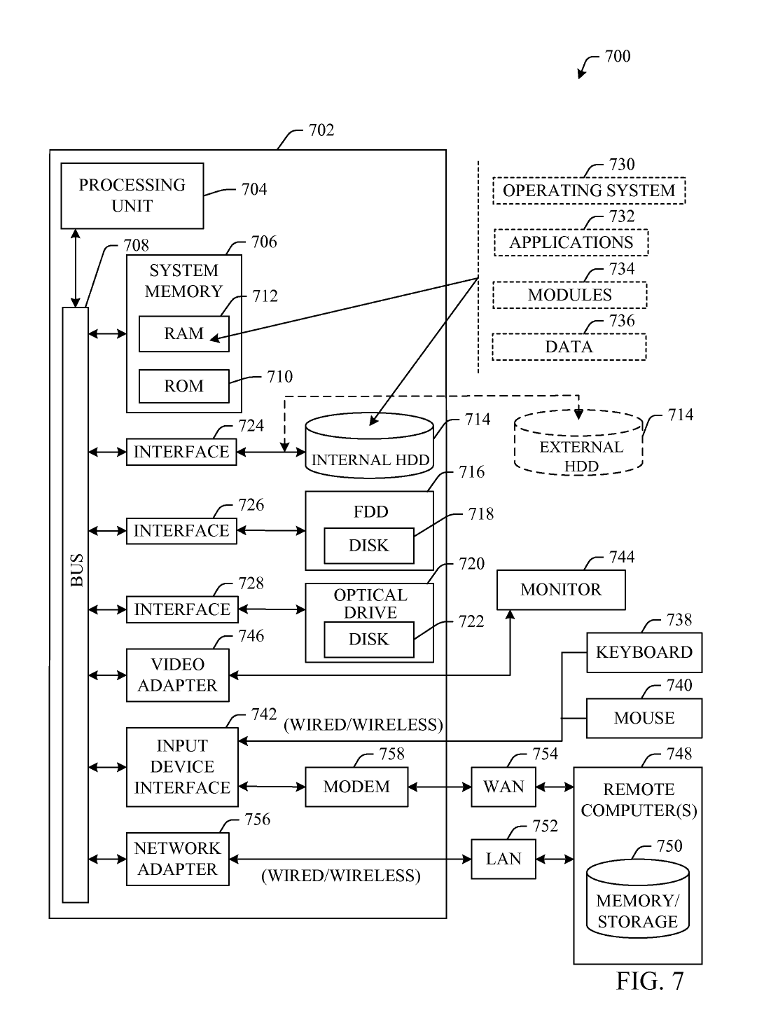

Referring now to FIG. 7, there is illustrated a block diagram of a computer operable to execute the disclosed architecture. In order to provide additional context for various aspects of the subject specification, FIG. 7 and the following discussion are intended to provide a brief, general description of a suitable computing environment 700 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the example environment 700 for implementing various aspects of the specification includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the specification can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are example and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method to communicate one or more date and/or time data types across a SQL environment comprising:
identifying one or more characteristics of the one or more date and/or time data types according to a selected granularity comprising time zone for communication across a SQL environment; and
generating one or more wire formats comprising packets of a selected SQL communications protocol for the one or more date and/or time data types according to the one or more identified characteristics.

2. The method as recited in claim 1, further comprising generating the one or more wire formats according to parameters of a selected SQL communications protocol.

3. The method as recited in claim 1, further comprising processing the generated one or more wire formats according to one or more instructions executing in a data type engine.

4. The method as recited in claim 3, further comprising translating a string query by the data type engine to generate the one or more wire formats.

5. The method as recited in claim 3, further comprising reconstituting the generated one or more wire formats into a string.

6. The method as recited in claim 1, further comprising communicating the generated one or more wire formats from a SQL client to a SQL server.

7. The method as recited in claim 1, further comprising communicating the generated one or more wire formats from a SQL server to a SQL client.

8. The method as recited in claim 1, further comprising generating the one or more wire formats as part of communicating a query from a SQL client to SQL server.

9. The method as recited in claim 1, further comprising receiving a generated one or more wire formats by a SQL server to process one or more SQL operations.

10. The method as recited in claim 1, further comprising receiving a generated one or more wire formats by a SQL client as a result of one or more SQL operations.

11. A system for communicating one or more date/time data types across a client/server SQL environment comprising:
a data type engine operable to receive string data to generate one or more date/time data type one or more wire formats according to one or more characteristics of the one or more date/time data types,
wherein the generated one or more wire formats comprise packets of a selected SQL communications protocol; and
a transmission component cooperating with the data engine to communicate generated one or more wire formats between a SQL client and a SQL server.

12. The system as recited in claim 11, wherein the generated one or more wire formats are generated according to one or more requirements of the selected SQL communications protocol.

13. The system as recited in claim 11, wherein the generated one or more wire formats comprise binary data.

14. The system as recited in claim 11, wherein the one or more characteristics of the one or more date/time data types comprise a fractional temporal granularity expressed as XX:XX:XX.XXXXXXX and time zone.

15. A computer implemented method to process one or more date/time data types employing custom wire formats comprising the steps of:
associating one or more custom wire formats to one or more date/time data types, the custom wire formats being generated according to one or more requirements of a selected communications protocol and to a selected temporal granularity comprising time zone; and
communicating the associated custom wire formats using a transmission component operative between two computing environments.

16. The method as recited in claim 15, further comprising selecting a tabular data streaming (TDS) SQL communications protocol.

17. The method as recited in claim 16, further comprising defining one or more data tokens for the one more data/time data types.

18. The method as recited in claim 17, further comprising deploying the defined one or more data tokens across a client/server SQL environment operable when processing the one or more date/time data types between a SQL client and a SQL server of the client/server SQL environment.

19. The method as recited in claim 18, further comprising creating the one or more custom wire formats having binary data representations.

20. The method as recited in claim 19, further comprising associating the one or more data tokens to the one or more date/time data types.
